(19) United States
(12) Patent Application Publication
(10) Pub. No.: US 2008/0091820 A1
(43) Pub. Date: Apr. 17, 2008

(54) Multiple-listing referral tracking system

(76) Inventors: John G. Norman, Cambridge, MA (US); Stanley M. Ward, South Hamilton, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/548,962

(22) Filed: Oct. 12, 2006

(51) Int. Cl. G06F 15/173

(52) U.S. Cl. 709/224

(57) ABSTRACT

A referral-tracking system accepts listings from originators and generates referral identifiers that represent referrals of those listings. A referral identifier represents a referral by the originator or by someone who, after receiving a listing identifier from an originator or someone else, applies to the system to be recognized as a referrer and has accordingly been issued a referral identifier that associates that requester with a listing to be referred. An originator or other requester applying for a referral identifier is given the option of identifying intended recipients to tracking system or not. If the requester does supply the tracking system with that information, the issued referral identifier is associated not only with the listings and the referring requester but also with the recipient. In that way, the system can provide conversion-rate information without discouraging participation by potential requesters who prefer not to divulge the recipients' identities.

### BACKGROUND OF THE INVENTION

1. Field of the Invention

This disclosure relates to the representation and tracking of listing referrals.

2. Background Information

Widely disseminated but relatively indiscriminate media such as newspapers are often used to elicit offers to take a job, make an investment, buy property, etc. But the most effective and efficient way to elicit interest often turns out to be the use of personal-referral networks: acquaintances communicate an opportunity's availability selectively to people they know. Recognizing this, many enterprises disseminate job listings to their contacts, such as existing employees, and provide incentives, such as employee-referral bonuses for identifying successful candidates.

The Internet and other computer networks have enhanced that approach's efficiency, and network services have evolved that employ that approach. In one type of service, for example, a person wishing to create and propagate a listing (such as an originator who wants to attract job applicants) uploads the listing to a central server. The originator also sends the central server a list of e-mail addresses of some of the originator's contacts, and the server thereupon sends those contacts messages that describe the listing and give the URL of a web page where the messages' recipients can express interest in the offer and/or provide the e-mail addresses of some of their own contacts—to whom the central server further propagates the listing.

Services of this type lend the speed of Internet communication to the targeted propagation of personal referrals. Since the central server receives the referrals and sends the resultant offer-eliciting messages, such services can provide an automated way of implementing rewards systems and/or keeping track of which referral sources prove most effective.

Now, one early impediment to taking advantage of this potential arose from the facts that people often consider their contact lists confidential information and that they are often reluctant to send a recruiter a contact's name without first discussing it with the contact. Such discussions very frequently never take place, with the result that valuable referrals fail to occur.

Commonly assigned co-pending U.S. patent application Ser. Nos. 11/092,397 and 11/212,265 for Referral Tracking, which were filed by Rowe et al. on Mar. 29, 2005, and Aug. 26, 2005, respectively, and are hereby incorporated by reference, disclosed a way of reducing this impediment: they provided a way of automatically tracking referrals without requiring the referring party to disclose his contacts to a central server. And our commonly assigned co-pending U.S. patent Ser. No. 11/278,334 for Multiple-Listing Referral Tracking, which was filed on Mar. 31, 2006, and is hereby incorporated by reference, extended that concept to enable multiple listings to be distributed simultaneously.

In the arrangements described in those applications, a party who wants to refer the listing and get credit for doing so contacts the tracking system to obtain a referral identifier that associates that requester with a listing or listing to be referred. The requester then sends that identifier to his contact or contacts in messages that invite expressions of interest or further referral. Someone who thereby receives the identifier and wants to refer the listing further similarly contacts the system as a requester and similarly obtains an identifier that is associated with that requester as a potential referrer. By keeping track of which identifiers were issued in response to reception of which other identifiers, the system is able to track referrals and accord credit properly.

### SUMMARY OF THE INVENTION

We have found ways to improve automated referral further.

One such advance is a small operational change that can result in a significant increase in a referral-tracking system's value. In some cases we have the referral tracker issue referral identifiers with which it associates more than one listing and the intended recipient as well as the requester. This enables the requester to have more than one listing sent simultaneously to the same recipient while at the same time affording an enhanced capability to judge the effectiveness of the originator's approach to recruitment and similar campaigns. We refer to such referral identifiers as “directed” multi-referral identifiers, as opposed to “undirected” ones, with which the system does not associate recipients when it issues them.

Another advance that we have is, instead of always sending the identifier to the recipient or always to the requester, to provide the requester a choice between sending the referral himself and having the system send the identifier to the recipient directly. This advance is particularly advantageous when it is combined with the previous one. As was observed above, having the system associate recipients with identifiers when it issues identifiers requires the requester to tell the system something about the recipient, such as the recipient's e-mail address, and this can result in reluctance to use the system. But giving the requester a choice enables the system to afford some of the greater information-gathering capability of directed identifiers without discouraging participation by potential requesters who prefer not to disclose contact information without the contact's prior agreement.

### BRIEF DESCRIPTION OF THE DRAWINGS

The invention description below refers to the accompanying drawings, of which:

FIG. 1 is a block diagram of one type of workstation that a computer system implementing the present invention's teachings may include;

FIGS. 2A and 2B together (collectively, “FIG. 2”) form a logical diagram of a database used by an illustrated embodiment of the invention;

FIG. 3 is a screen shot of a web page by which a user enters listing information;

FIG. 4 is a flow chart of a routine that the illustrated embodiment follows in responding to submission of a listing;

FIGS. 5A and 5B (together, “FIG. 5”) constitute a flow chart of a routine used to respond to a referral request;

FIG. 6 is a screen shot of a web page that a user employs to choose between obtaining referral identifiers that the user can use his e-mail client to send and asking the listing-referral system to send referral identifiers directly to recipients;

FIG. 7 is a screen shot of an e-mail message that contains a referral identifier;

FIG. 8 is a screen shot of a web page that presents a requester a referral-identifier-containing message to be used by that requester to refer a listing;

FIG. 9 is a screen shot of a web page that can result when a recipient of such a message follows a URL that it contains;

FIG. 10 is a screen shot of a web page for entering information about a requester whom a referral identifier is to associate as a referrer with one or more listings;

FIG. 11 is a screen shot of a web page for entering information about a person who wants to express interest in a listing; and

FIG. 12 is a screen shot of a web page that the illustrated embodiment employs to give a user information about listings associated with that user.

### DETAILED DESCRIPTION OF AN ILLUSTRATIVE EMBODIMENT

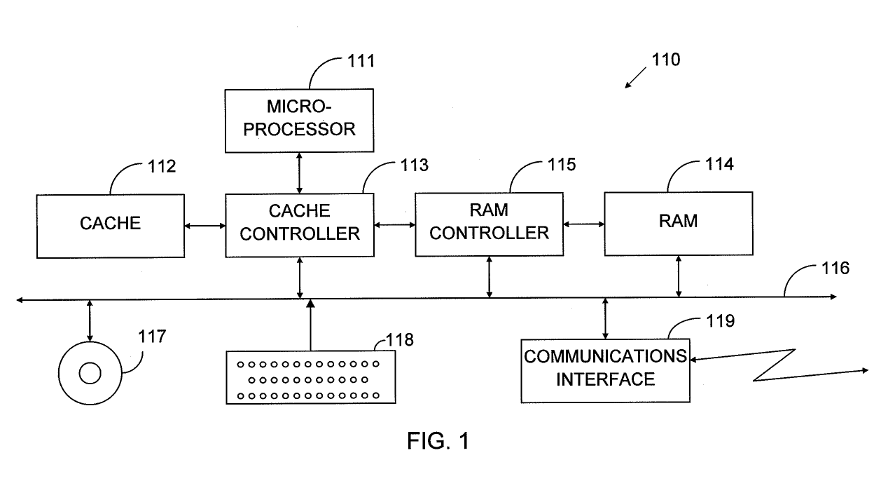

Referral-tracking approaches that employ the present disclosure's teachings will ordinarily be implemented in computer systems. Computer systems vary widely in architecture, so, although FIG. 1 depicts one type of workstation 110 that such a computer system may include, most will differ from it in one or more details.

Data that a microprocessor 111 uses and instructions to be executed by the microprocessor 111 may reside in on-board cache memory or be received from further cache memory 112, possibly through the mediation of a cache controller 113. That controller 113 can in turn receive such data and instructions from system read/write memory (“RAM”) 114 through a RAM controller 115 or from various peripheral devices through a system bus 116. The memory space made available to an application program may be “virtual” in the sense that it may actually be considerably larger than RAM 114 provides. So the RAM contents are often swapped to and from a system disk 117.

Additionally, the actual physical operations performed to access some of the most-recently visited parts of the process's address space often will actually be performed in the cache 112 or in a cache on board microprocessor 111 rather than on the RAM 114. Those caches would swap data and instructions with the RAM 114 just as RAM 114 and system disk 117 do with each other.

Independently of the particular memory arrangement that a particular workstation employs, it will often include some type of user-input device such as a keyboard 118 or mouse (not shown). By using such devices, the user enters data and commands as appropriate.

The computer system may include more than one such microprocessor, and a given one of the microprocessors may share some or all of the persistent-storage facilities with one or more other such microprocessors. The persistent-storage facilities will typically store the instructions that configure the computer system as the referral-tracking system described below, but such instructions, possibly of the type to be executed by a virtual machine that the computer system can be software-configured to implement, can in principle be loaded directly into memory from a remote source through a communications interface 119. One or more processors may use one or more such communications interfaces to implement the central-server function described below.

The system described herein may be employed to propagate or distribute any kind of listings or offers through the personal-contact networks of the listings' originator(s) and recipient(s). For example, listings may be job listings, created by originators or hiring managers searching for an employee to fill a position. Alternatively, listings may be created by people seeking contractors to provide specified services. Listings may instead relate to real estate or other property, such as antiques or collectibles, offered for sale or rent by an owner, seller, or broker. Or they may be created by a prospective buyer seeking an opportunity to make an offer on real estate or other property.

Furthermore, a user may group multiple types of listings together to refer a group of listings to a contact. For example, one or more listings in a group may be job listings while other listings in the group may be real-estate listings, furniture listings, clothing listings, or any other type of listing or combination of types of listings. The system described may be employed in any instance in which an originator of at least one listing wishes to distribute any kind of offer, request, or opportunity through his or her own personal-contact network and the personal-contact networks of the listing's recipient(s). The above examples should be understood to be exemplary rather than exhaustive.

The following description of an exemplary embodiment of the invention presents an example in which all the listing's originators are employers, or the agents of employers, that are seeking to fill one or more job positions. In the example, each “listing” represents the job position to be filled. A recipient of a group of listings may choose to express interest in one or more of the positions himself and/or may choose to refer positions to others who may be interested in applying for one or more of the positions. In some cases, the person or other entity that originates a listing is not the same as the person who decides which applicant (job applicant, bidder, etc.) will be chosen to fulfill the listing, and both may be different from the person or entity that issues any resultant awards. However, the description below will use the term “originator” collectively to refer to the entity or entities that perform one or more of such functions.

In this illustrated embodiment, the system creates an account unique to the particular originator before it allows the originator to enter listing information. To edit or retrieve information pertaining to the listings that the originator has created or received from others, the originator may subsequently access his or her account by using a password. The system may create an identifier associated with the originator (and, as will be seen, other users) in its database so that this information can be accessed in the future and enable the system to associate the user with listings.

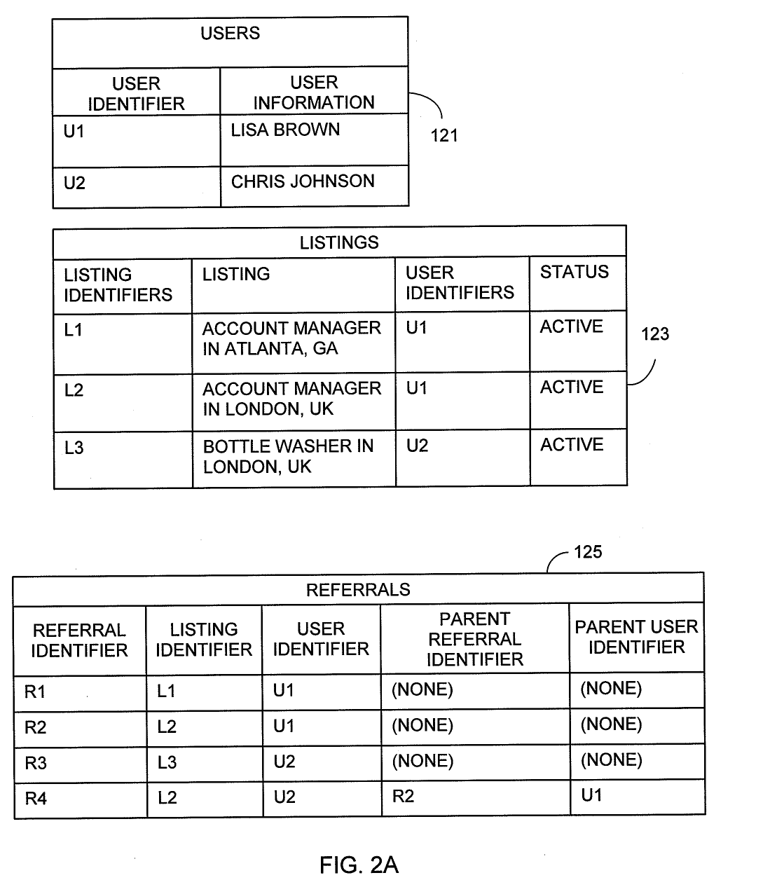

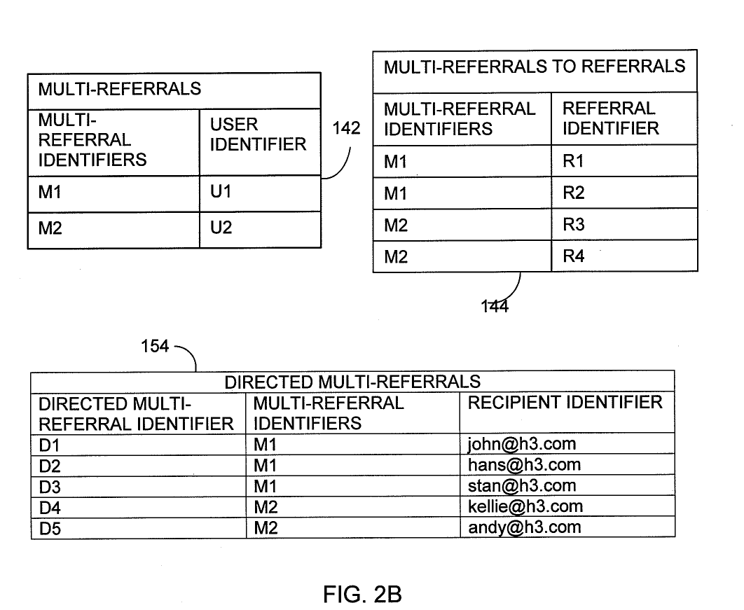

FIG. 2, which is a simplified logical database diagram showing selected columns of selected database tables, will be used to show one approach a system could use to keep track of users and other data. A user table 121 could be used to contain a record for each user. For the sake of simplicity, that drawing shows only two of the table's typically more columns. One of those columns, the user-identifier column, contains values of that table's key attribute, on which a database management system enforces uniqueness.

The drawing depicts one such user identifier, U1, as having been created to identify a originator named Lisa Brown. U1 will be used to associate Lisa Brown with each listing that Lisa Brown creates. In alternative embodiments, information about the originator may be entered along with information about the listing. In such embodiments, an originator may not necessarily need to create an account.

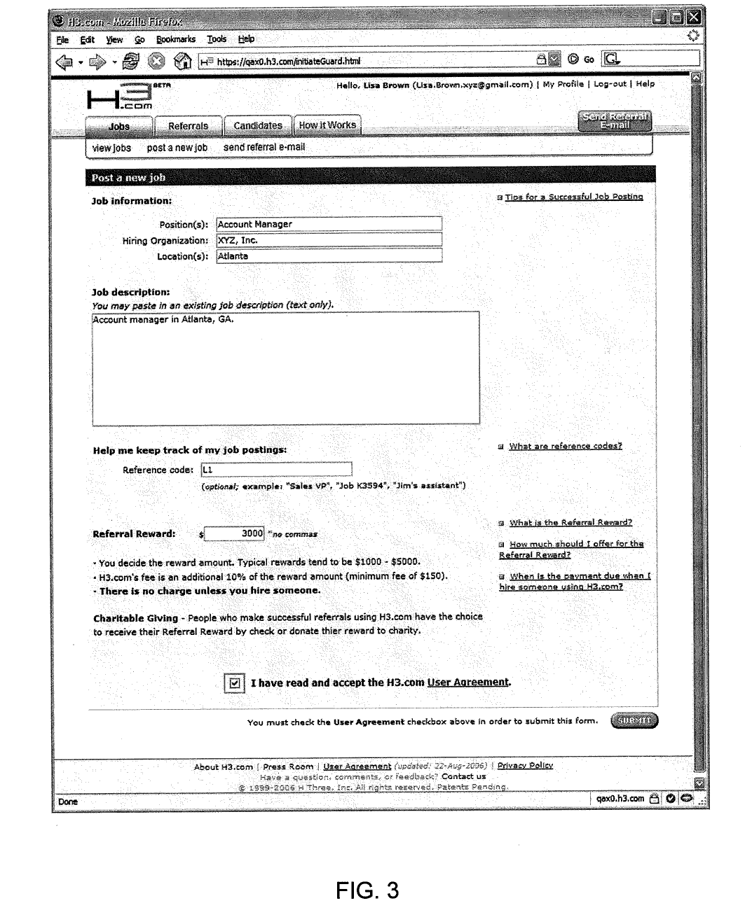

In the illustrated embodiment, an originator can access the system through the Internet and, by using a web-page interface, create a plurality of listings that the originator wants to propagate. FIG. 3 depicts an example web-page interface for creating a listing. The information entered in this web page is used to create a listing identifier such as the ones stored in listing table 123 of FIG. 2. The information shown entered in the FIG. 3 web page, for example, corresponds to the entry labeled L1 in FIG. 2's table 123.

An originator can submit entered information by clicking on the “Submit” button illustrated in FIG. 3. This causes the originator's browser to send the system a message containing the information entered in the interface. In alternative embodiments, the originator may supply information about the listings by sending the system an e-mail message or any other transmission. The message may, for example, be an e-mail message so formatted that the system can read information about a listing automatically, without human intervention.

In some embodiments, an originator may enter multiple listings simultaneously; this may be done, for example, in a specially formatted e-mail message containing listing separators that the system can identify as the end of one listing and the beginning of another listing. In other embodiments, a system-to-system transfer may occur automatically, without human intervention. A corporation's internal applicant-tracking system, for example, may send job listings to a referral-tracking system automatically when they meet certain criteria, such as having been offered internally for more than a predetermined length of time. For the purposes of the present discussion, any listing-related information received by the system in any way, including by a web-page interface or e-mail, is considered a listing-containing message from an originator.

Each listing may include information about the organization or person on whose behalf the listing is created. Each listing may also include a job title and/or a brief description of the job as well as the job's geographical location and any other information pertinent to the offer described. The originator may also assign each listing a reference code that is to be included in further communication about that listing between the originator and the system. (Although FIG. 3 depicts the originator's reference as being the same as the listing identifier, “L1,” that the system used for that listing, the originator's reference will more typically differ from the system's, and it need not be unique.)

Some embodiments may include provisions for associating rewards with listings. Rewards may be offered, for example, by the organization or person on whose behalf the listings are created. In the case of a job listing, the reward would typically be awarded when a listed position is filled successfully through the system. If one listing invites applicants for more than one job position, a reward may be distributed each time a referred candidate is hired for one of the positions. As will be described below, that system may determine which requesters will receive a share of the reward. The “Referral Reward” box in the FIG. 3 web page is the mechanism by which the originator can specify the award in that embodiment. A recipient who qualifies for a share of the reward in that embodiment has the option of accepting payment of the share of the reward or of redirecting that payment to a charity. The system may allow the originator to recommend a charity to which the reward should be directed. In some embodiments, the originator selects the recommended charity from a list of charities that the system provides. In other embodiments, the originator may select any charity he desires by entering identifying information for that charity.

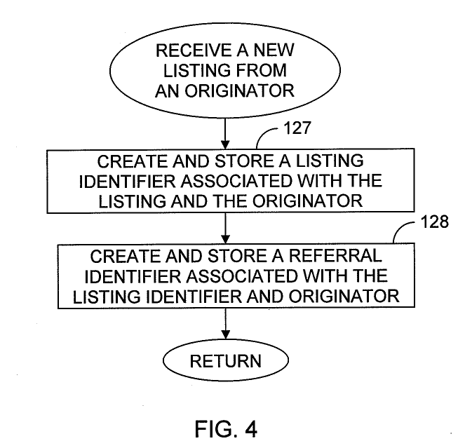

FIG. 4 is a flow chart that shows how the illustrated embodiment responds when it receives a listing-containing message from an originator. When such a message arrives, the exemplary system generates a unique listing identifier, such as “L1” in FIG. 2's table 123. It also associates that identifier with the listing, the originator, and the rewards, and it stores that identifier in the database. FIG. 4's block 127 represents those operations. In the illustrated embodiment, originators submit only one listing at a time, but embodiments that allow multiple simultaneous listing submissions may generate a listing identifier for each listing submitted.

As block 128 indicates, the illustrated embodiment then creates a “referral identifier.” As will be explained in more detail below, the system uses referral identifiers to identify potential listing referrals by users who request identifiers, so a referral identifier is associated with the combination of a requester (here, the originator) and at least one listing. The referral identifiers that the system creates in the FIG. 4 routine are placed in FIG. 2's referral table 125. For example, referral identifier R1 associates U1 (Lisa Brown) with listing L1 (the Atlanta account-manager position). The example database is so organized that each referral identifier in table 125 associates a user with only a single listing. As will be seen below in connection with other tables, though, not every referral identifier is restricted to associating its respective user with only a single listing.

As will also be explained in more detail below, the system or the requester sends a referral identifier to anyone to whom the requester wants to refer the listing, and the recipient can submit that referral identifier to the system to elicit consideration for the job—or to request another referral identifier, one that will qualify that recipient as a potential referrer of that listing. By thus receiving referral identifiers that it has associated with respective potential referrers, the system can track who referred what listings to whom.

To begin the referral chain, the originator will need a referral identifier in the illustrated embodiment even though the originator will not typically qualify for the reward. Now, the invention can be practiced without assigning referral identifiers to originators. Also, although FIG. 4's block 128 indicates that the illustrated embodiment automatically responds to a listing's creation by generating a referral identifier associated with that listing and the originator, some embodiments that do assign originators referral identifiers may instead defer referral-identifier creation until the originator makes a separate request for one. One reason for such deferral could be that the originator may end up referring a given listing only in combination with other listings, so the only referral identifier needed would be one that associates the originator with a combination of listings, not with just one. As will be seen below, though, the particular database design used by the illustrated embodiment requires a separate referral identifier for every referred listing, even if some are not referred separately, so it makes sense in the illustrated embodiment to create the referral identifiers automatically when the listings are created. Also, although the drawing depicts only five of the table's columns, the referral table may include other columns to include information, such as the date of creation, that makes creating an identifier right away convenient or necessary.

Referral identifiers “R1” and “R2” in the first two rows of FIG. 2's referral table 125 reflect the results of Lisa Brown's creating two listings: that table associates these identifiers, which may, for example, be generated as Universally Unique Identifiers (UUIDs), with listings L1 and L2, respectively, and with U1 (Lisa Brown) as the potential referrer.

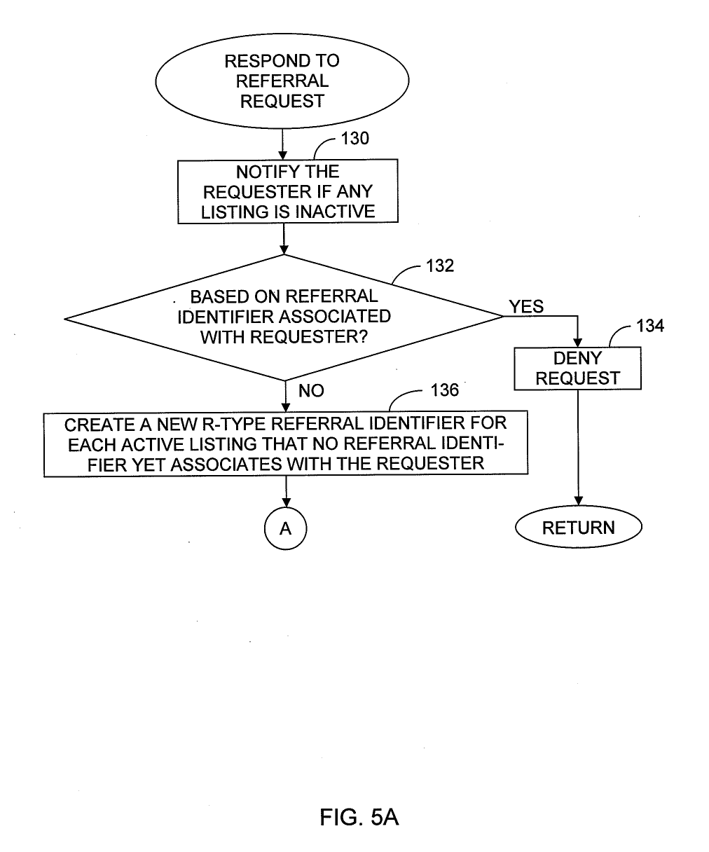

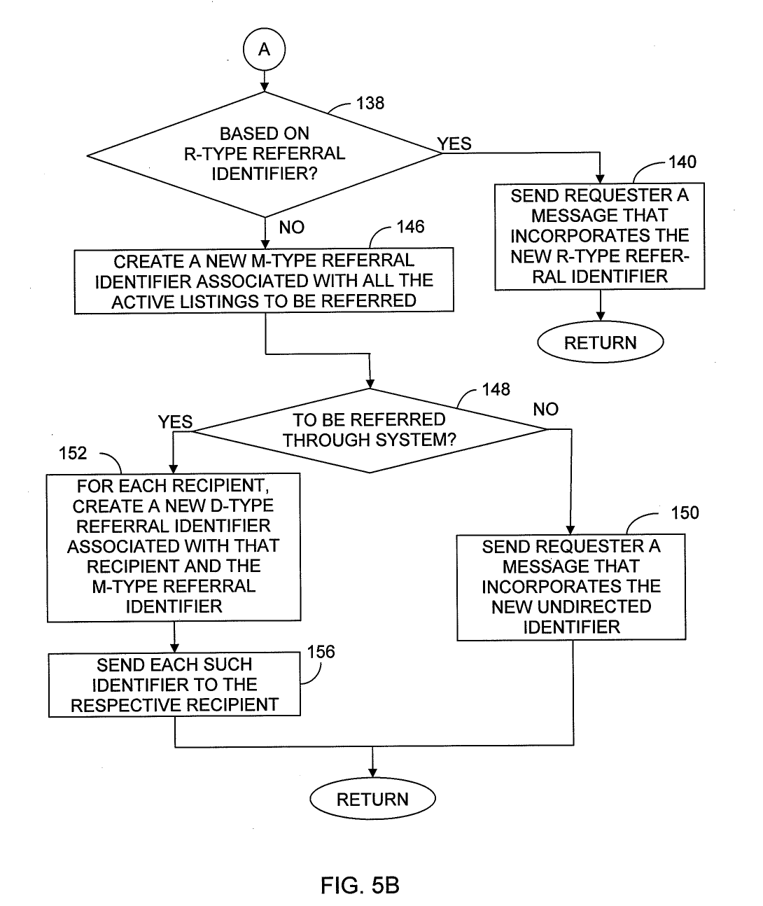

At some point the originator typically will then request that one or more listings be referred. That system's response to such a request, whether it is from the originator of the listing or from some other requester, one to whom the listing has been referred, can take any form that results in referring listings that the requester selects. For the sake of example, though, we will assume a response operation of the type that FIG. 5 illustrates. In the case in which the referral request is made by the listings' originator during the initial listing-entry session, the set of listings from among which the requester wants to select is apparent. In many cases, though, the originator is returning to make the referral request in a different session, or the requester is some-non-originator party to whom listings have been referred. In such cases the requester makes the request by sending the system a message containing identifiers of the listings from among which the requester will select.

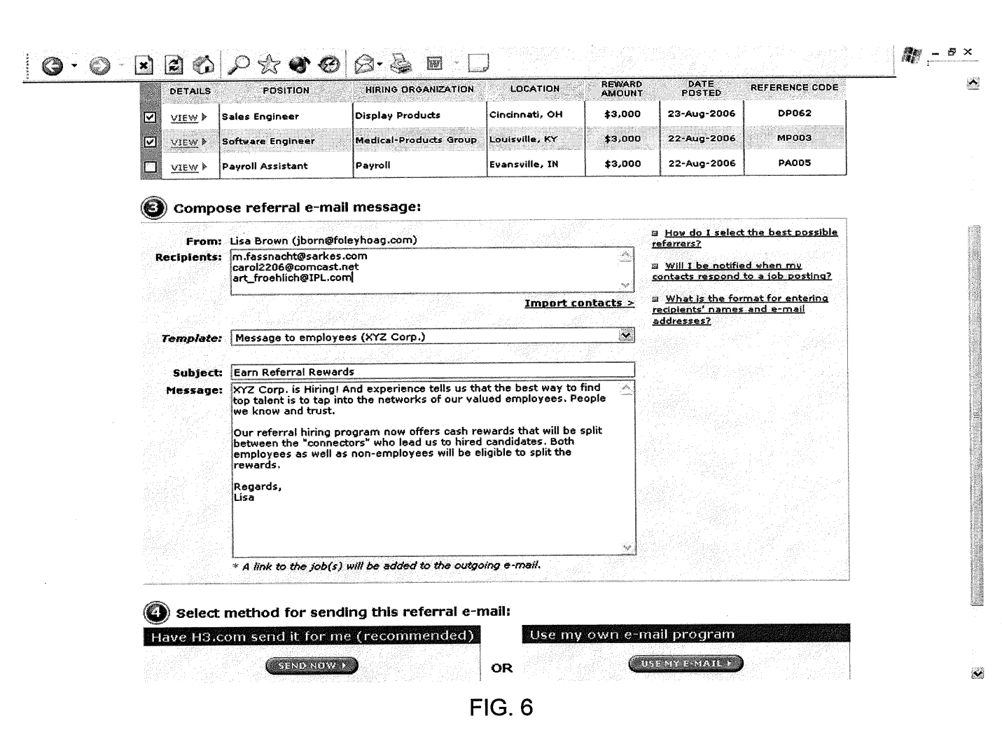

FIG. 6 depicts a web page that is one way in which such a request can be made. As that drawing shows, that page presents the requester a set of listings. The set may be compiled in any appropriate way. If the requester is an originator in the midst of a listing-creating session, the displayed listing set may include all the listings that the originator entered during that session, or maybe in that session and all previous ones. Independently of whether the requester is an originator, the set may additionally or instead include the listings that the system has associated with the requester in some other way; it may, for example, include those for which the requester has previously obtained referral identifiers and/or in which he has previously expressed interest. Or it may include all those that were created by some originator of whose listings the requester has previously indicated he wanted to be notified.

Particularly if the requester is a previously unknown user, the set may simply be the listings that a message from that requester identified. One type of such message, for instance, would be an HTTP message that the user's browser sent the system's server in response to the user's clicking on a hyperlink in a referral e-mail message; an identifier of the listings could be incorporated in the message's destination URL.

In any event, the requester uses the check boxes in the FIG. 6 web page's upper left corner to select listings to refer, and he submits this selection to the system by clicking on that web page's “Send Now” or “Use My E-Mail” button. The result is that the user's browser sends the system a message that in some fashion identifies the listings the user has chosen.

The message can make this identification in any convenient way. The message can, for example, include a separate identifier for each selected listing. Or the list of referral identifiers may include a referral identifier for every listing, whether checked or unchecked, and the message can include a bitmap that the system uses to determine which listings are checked. (E.g., each referral identifier with a position matching a 1 in the bitmap can correspond to a checked listing.) Alternatively, instead of sending a single message that contains a list of identifiers, the requester's browser may send a message each time the requester checks or unchecks a box, and it may respond to the requester's then clicking on a button by sending a final message that specifies the action to be performed. Any other method can be used so long as the system can identify the listings the requester has selected.

When the requester is someone other than the originator; there may have been some time delay between when the requester was notified of the listings and when he makes a request for a further identifier. In that time, the listing may have become inactive. (A listing may become inactive when, for example, the originator withdraws it, typically because all offered jobs have been filled, all offered items have been sold, etc.) Some embodiments may alert the requester to that fact, as block 130 indicates.

In any event, the system then needs to make sure that it has assigned a referral identifier with the proposed referral. As was mentioned above, the illustrated embodiment will already have created a referral identifier for each of the listings if the requester is an originator, but the requester is not always the listings' originator. So the system may need to create new referral identifiers.

Before it does so, though, it needs to make use the request is valid. When the requester is not the originator, the request will be accompanied by the referral identifier of which that requester was the recipient; as will become apparent, the system uses that information to keep track of referral chains. It can sometimes happen, though, that the user associated with the referral identifier thus submitted with the request is the requester himself. In such a case, any resultant referral identifier issued in response to the request would suggest a referral from that requester to himself. The illustrated embodiment is designed to prevent such self-referrals in any recorded referral, so, as blocks 132 and 134 indicate, the system denies the request when that happens.

Otherwise, as block 136 indicates, the system creates any necessary referral identifiers required to associate the requester with the listings to be referred. Specifically, it places referral identifiers into FIG. 2's table 125. We will call such referral identifiers—i.e., referral identifiers that serve as that table's key—as “R-type” referral identifiers, to distinguish them from referral identifiers of two other types to be described below.

In the example of FIG. 2, for instance, suppose that the requester is a user Chris Johnson, to whom Lisa Brown referred her listing L2 in a referral identified by referral identifier R2. Suppose further that Chris Johnson has himself entered a listing, which is identified in the listing table 123 by identifier L3. If Chris chooses to refer listings L2 and L3, the system responds to the resultant message from Chris's browser by generating referral identifier R4, and it associates that identifier in referral table entry 125 with listing identifier L2 (corresponding to Lisa's listing for an account manager in London), user identifier U2 (corresponding to Chris), and parent referral identifier R2 (which is the identifier by which Chris specified L2 as a listing for which he wanted a referral identifier designating him the referrer). (Of course, those skilled in the art are familiar with many other ways of recording parent-child relationships between objects, and some other embodiments may employ such other ways to designate the new identifier as a child of a previous identifier.) The system does not need to create a new referral identifier for listing L3, because Chris is the originator of that listing, so an existing referral identifier R3 already associates that listing with Chris.

As was stated above, non-originator requesters present referral identifiers to the system with their requests so that the system can track referral chains. For reasons that are not germane to the invention, it happens that the way in which the illustrated embodiment processes requests depends on the type of referral identifier the requester presents. If it is an R-type referral identifier—i.e. one that is found in table 125's key column—then, as blocks 138 and 140 indicate, the system simply sends the requester the newly generated referral identifier of that type.

Now, recall in this connection that the way in which the non-originator requester typically submits the referral identifier is to click on a web-page button, such as one of those in FIG. 6, that has been arranged to include that referral identifier in the transmission that the requester's browser sends in response to the requester's clicking on that button. Furthermore, the reason why the web page is so arranged is that the same referral identifier was included in the URL sent when the user, say, clicked on a hyperlink in an e-mail message by which he received the referral. And, for reasons that will become apparent, the web page that the illustrated embodiment sends with that referral identifier is an R-type referral identifier differs from the FIG. 6 web page in that it has only a single request button in place of the “Send Now” and “Use My L-Mail” buttons.

As perusal of FIG. 2's table 125 reveals, each R-type referral identifier is associated with the requester and only a single listing. But the originator may request referral of more than one listing at a time, and non-originator requesters may, too, as will be explained directly. Therefore, if the request is not based on a (single-listing-only) R-type referral identifier, the system provides for identifiers so stored as to enable them to represent more than one listing if necessary. The particular database design employed by the illustrated embodiment uses two tables for that purpose: FIG. 2's tables 142 and 144, which contain what we will refer to as “M-type” referral identifiers.

As FIG. 2 indicates, table 142 associates the M-type referral identifier (here, M1) with the potential referrer (U1, i.e., Lisa Brown), and table 144 associates the M-type referral identifier with the listings. That particular database design uses R-type referral identifiers in table 144 instead of listing identifiers to specify the listings with which that table associates the multi-referral identifier. (This is the database-design feature mentioned above as requiring allocation of a single-referral identifier with each listing that is to be referred, even if it never gets referred individually. Obviously, completely different database organizations, too, can be use to practice the present invention's teachings.)

FIG. 5's blocks 138 and 146 indicate, the system creates in FIG. 2's tables 142 and 144 an M-type referral identifier associated with the requester and the set of listings to be referred if the request was not based on an R-type referral identifier. In the FIG. 2 example, for instance, the system creates new M-type referral identifier M2 and places corresponding entries in FIG. 2's tables 142 and 144. The entry in table 142 associates new identifier M2 with Chris (U2). The entries in table 144 associate new identifier M2 with R-type referral identifiers R3 and R4.

Note that M-type identifier M2 identifies referrals whose lineages differ: the referral represented by R3 has no parent, whereas the one represented by R4 has as its parent the referral that R2 represents. So one cannot always associate a single parent with an M-type referral identifier. To provide a related concept that can be single-valued, some embodiments may assign multi-referral identifiers a “source” property. That property may, for example, be the identifier that the requester of the M-type referral identifier used in requesting it. Other embodiments may identify the parent M-type referral identifier as the M-type referral identifier received by the requester that is associated with the largest number of listings also associated with the newly generated multi-referral identifier.

In the illustrated embodiment, the system generates a new M-type referral identifier each time a user requests an M-type referral identifier for a set of listings, regardless of whether it has previously done so for that user and set of listings. In other embodiments, the system may instead use such a previously generated M-type referral identifier if one exists.

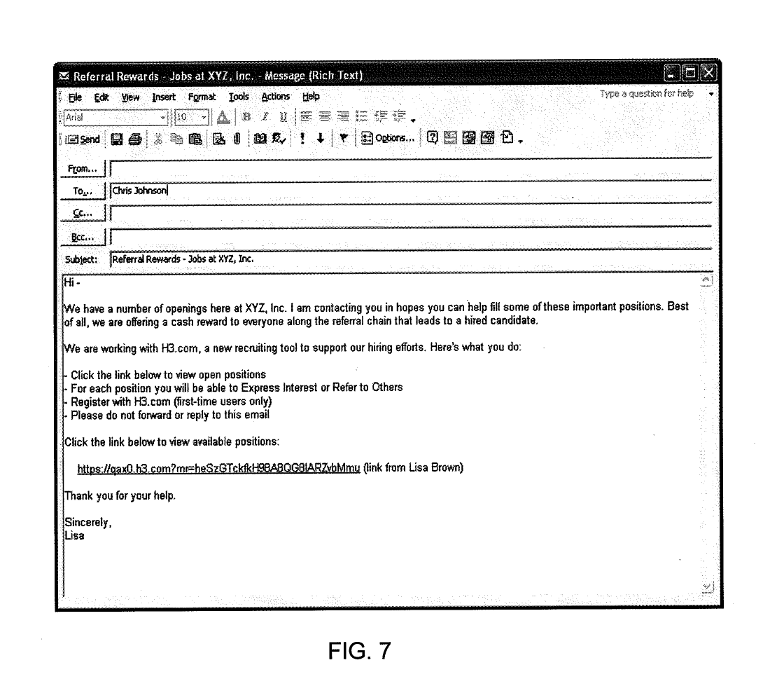

What happens after the system creates an M-type referral identifier (FIG. 5, block 146) depends in the illustrated embodiment on whether the button used to submit the listings is FIG. 6's “Send Now” button or its “Use My E-Mail” button. Let us first consider what happens if the user has selected the “Use My E-Mail” button. The “Use My E-Mail” button indicates that the requester wants to use his own e-mail client to send the job listing to a contact or contacts rather than have the system do it for him. The negative branch from FIG. 5's block 148 represents this selection. As block 150 indicates, the system responds by sending the user the (sometimes multi-referral) M-type referral identifier that it created in the block-146 operation. In the illustrated embodiment, the system does this by sending the user the body of a referral-identifier-containing e-mail message. FIG. 7 depicts an example of such a message displayed by the e-mail client of a requester who will use it to refer the listing. That message's body contains a hyperlink whose reference-field URL incorporates the identifier.

As FIG. 7 illustrates, the hyperlink may display that URL explicitly; the URL in that drawing is https://qax0.h3.com?mr=heSzGTckfkH98A8QG8|ARZvbMmu. We assume for the sake of this example that heSzGTckfkH98A8QG8|ARZvbMmu is an M-type identifier that the system generated when Lisa Brown chose to refer multiple listings she entered; i.e., the illustrated embodiment incorporates that identifier by simply including it without transformation in the URL as the value of a parameter named “mr.”

We digress at this point to note that the illustrated embodiment uses different parameters to pass different types of referral identifiers. In the FIG. 7 example, the parameter named “mr’ is used to pass the referral identifier because that referral identifier is an M-type referral identifier. It would pass R-type and D-type referral identifiers as values of parameter named “r” and “dmr,” respectively. Of course, the present invention's teachings can be practiced in systems that do not use different types of referral identifiers. Even those that do and incorporate those different types in URLs do not have to use different parameter names for that purpose. When the illustrated embodiment makes FIG. 5's block-138 determination, for example, it could infer the referral identifier's type from whether it is referral table 125's, multi-referral table 142's, or directed multi-referral table 154's left column in which that referral identifier is found. But the illustrated embodiment relies on the parameter type instead to save time.

Not all embodiments that incorporate a referral identifier in a URL will necessarily embed it in a hyperlink. In some, for example, an e-mail message may simply include a plain-text URL for the recipient to copy and paste into the address bar of a web browser. Instead of containing the identifier explicitly, the URL may contain it in any transformed, transposed, or other form from which the identifier can be inferred. For the purposes of this discussion, a message of any kind (including information passed via a web-page interface or via e-mail), a URL, or a hyperlink that includes a referral identifier or multi-referral identifier in any form that can be derived by the system (e.g., an exact copy of the identifier, an encrypted transformation of the identifier, a hash key signifying the location of the identifier, etc.) should be understood to “incorporate” that identifier.

Also, although the illustrated embodiment employs only a single parameter to incorporate referral identifiers, some embodiments that incorporate referral identifiers in URLs may employ a plurality of parameters collectively for that purpose. Instead of generating a separate UUID as the identifier for a given referral, for example, some embodiments may use as the identifier a (referral ID, user ID) pair or a (listing ID(s), user ID, parent ID(s)) tuple (in which the parent IDs could be a reserved null value for each listing for which the referrer is an originator). An M-type multi-referral identifier could also be implemented as a (R-type referral IDs, user ID) tuple in which R-type referral identifier associated with the M-type referral identifier is identified separately in the R-type-referral-IDs list. In such embodiments, it may prove convenient to use separate parameters for respective components of the (composite) identifier.

And parameters are not the only way to incorporate a referral or multi-referral identifier in a URL. For example, some systems may provide a separate server page for each listing or each set of listings that are to be referred together, in which case the listing-ID(s) component of a composite identifier could be represented by the name of that page, while the user component would probably still be passed as a parameter. Such a URL for both of Lisa Brown's listings (L1 and L2) could look something like “http://serverName.com/XYZAccountManager(Atlanta)_XYZAccountManager(London).asp?u=heSzGTckfkH98A8QG8|ARZvbMmu.”

A message that incorporates a referral identifier can be configured to suit a particular user's needs. For instance, if an originator refers only jobs from one hiring or ganization, the message can be branded to reflect that hiring organization.

A referral-identifier-containing message may contain all or some of the originator-entered information about the listing. The message may also contain information about any reward offered by the originator or the organization or person on whose behalf the listing was created.

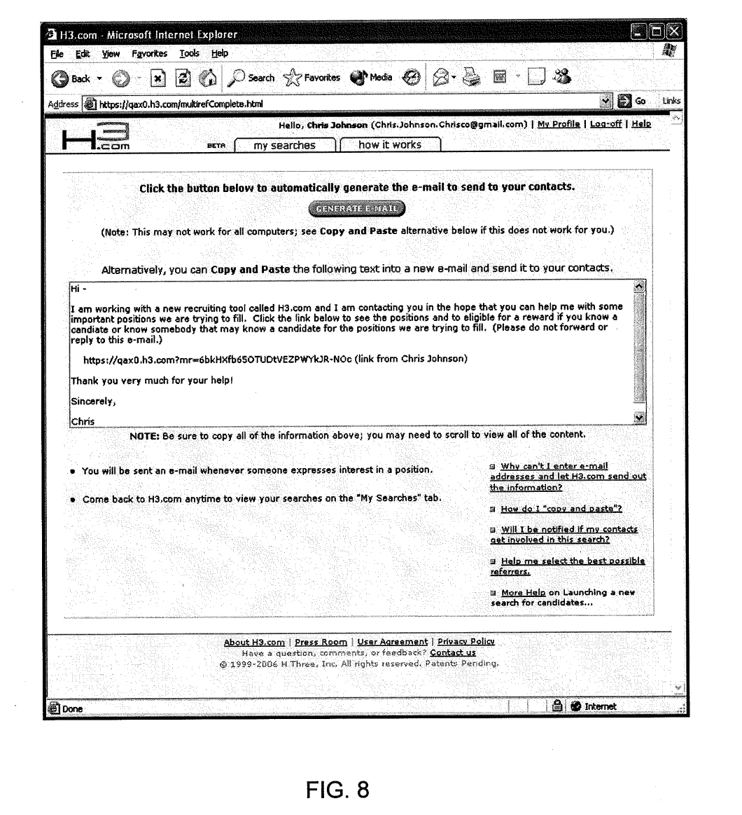

When the system sends the referral-identifier-containing message to the requester, it may also send with it the URL of or a hyperlink to a web page that provides the requester additional information and instructions, including the option to view information about the listing or listings. Indeed, the system may use a web page rather than an e-mail message to provide the identifier to the requester. This may be done, for example, by sending the requester's browser a web page that, e.g., displays the URL for the requester to copy and paste into one or more e-mails the requester will send to one or more recipients to whom the requester wishes to refer the listing or listings. FIG. 8 depicts an example of a web page that includes the identifier-incorporating URL. That web page gives the requester the option of copying text that includes the URL and pasting it into e-mail messages he will send recipients.

These recipients may be selected from the requester's own personal contacts. By using the “Use My E-Mail” button, though, the requester can protect his or her personal-contact list, since that approach does not require the requester to provide the recipients' e-mail addresses to the system. When that approach is taken, the system does not receive the identities or e-mail addresses of the chosen recipients unless the recipients decide to identify themselves to the system in order to apply for a job or get credit for a further referral. The intention is that, if the contact wants to participate in referring the listing to others and get credit for doing so, he will identify himself to the central server, identify the listing or listings in which he is interested, and be issued a further identifier, which the central server will associate with that contact.

For each listing that the recipient indicates either an interest in or an intention to refer, the system will create a new referral identifier associated with both the contact and the listing. Although the illustrated embodiment creates a referral identifier when a recipient expresses interest in a listing (and thereby, in the illustrated embodiment, becomes a requester), some embodiments may be so arranged that the system generates a referral identifier only if the requester indicates an intention to refer a listing to another person. One advantage of the illustrated embodiment's approach is that the referral table can be used to log expressions of interest, by way of a column (not shown in the drawings) that indicates whether the user expressed interest in response to that referral.

Each of the referrals represented by the new R-type referral identifiers will be treated as a child of a referral represented by the referral identifier associated with the person who referred the listing to the requesting recipient. If the referral identifier received by that recipient (and now requester) from the previous requester was not an R-type referral identifier, the system creates an M-type identifier associated with the referring requester and all the new R-type referral identifiers associated with the chosen listings, as was explained above in connection with FIG. 5. Subsequent recipients of referral identifiers will do the same, and, through the parent-child relationships of the referral identifiers, the system can track referral chains and identify the one that ultimately results in a job's being filled. This further-referral process is described more fully below.

Before we discuss the further-referral operations, though, let us consider what happens if, instead of using FIG. 6's “Use My E-Mail” button, the requester clicks on the “Send Now” button. That button indicates that the user does not want to send the listings himself. Specifically, it indicates that the requester wants to have the system send the listing to contacts that the requester supplies.

If that is the requester's choice, he will have placed a list of contacts in FIG. 6's “Recipients” web-page field before he clicks on the “Send Now” button, and his browser will include that list in the resultant identifier-requesting message to the system. In the illustrated embodiment, the system's response still includes creating the M-type referral identifier in the manner mentioned above in connection with FIG. 5's block 146. But, in addition to that M-type referral identifier, to which we will occasionally refer together with R-type referral identifiers as an “undirected” referral identifiers, the illustrated embodiment issues other referrals, to which we will refer as “directed,” or “D-type” referral identifiers. FIG. 5's block 152 represents issuing such identifiers.

A directed multi-referral identifier identifies not only a set of listings and the referrer but also a recipient to whom that listing set is being sent. The particular approach that the illustrated embodiment uses for this purpose employs FIG. 2B's “Directed Multi-Referrals” table 154 to associate respective D-type referral identifiers with different combinations of recipient and M-type referral identifier. In this embodiment, the recipient identifier is the e-mail address that the requester supplied in identifying the recipients.

As FIG. 5's block 156 indicates, the system sends the identifier-containing message directly to the recipients rather than to the requester if the requester has asked it to. As FIG. 6's “Message” window illustrates, though, the requester will typically have been given the opportunity to customize the wording that the message sent by the system will contain. The referral identifiers that the system includes in the messages to the recipients are D-type referral identifiers, each of which the system associates with a recipient and an M-type referral identifier that the system has associated with the user and the set of listings the recipient is to receive.

In contrast to the “Use My E-Mail” procedure, the “Send Now” procedure requires the requester to identify the recipient to the system even if the recipient has not chosen to have himself so identified. The requester may for this reason sometimes choose not to employ the “Send Now” procedure. As will become apparent, though, the “Send Now” procedure has the advantage that the originator can be given a richer set of statistics about how effective the selection of recipients has been.

To describe the referral process further, let us consider the above-described scenario, in which Lisa Brown and Chris Johnson are both originators., i.e., have both entered listings. If Chris later requests a referral identifier by logging on to the system, obtaining a web page similar to the one that FIG. 6 depicts for Lisa Brown, and choosing “Use My E-Mail,” the system sends that (say, M-type) referral identifier to Chris as a hyperlink in an e-mail-message body similar to the one that FIG. 7 illustrates as displayed in Lisa Brown's e-mail client. Chris then sends the identifier-including message body in an e-mail message he sends to a contact, one named, say, Mary Livingstone. Note that this all occurs without Chris's identifying Mary to the system.

Now consider the same scenario with the exception that Chris now chooses “Send Now” instead of “Use My E-Mail.” In that scenario, Chris enters Mary's e-mail address in the web page that contains the “Send Now” button, and his browser will include that address with the request for an identifier it sends when Chris clicks on “Send Now.” In response, the system sends the requested, D-type referral identifier not to Chris but directly to Mary. That identifier is a directed referral identifier—i.e., one that identifies not only the requester Chris and the listings but also the person, Mary Livingstone, he has designated as the recipient.

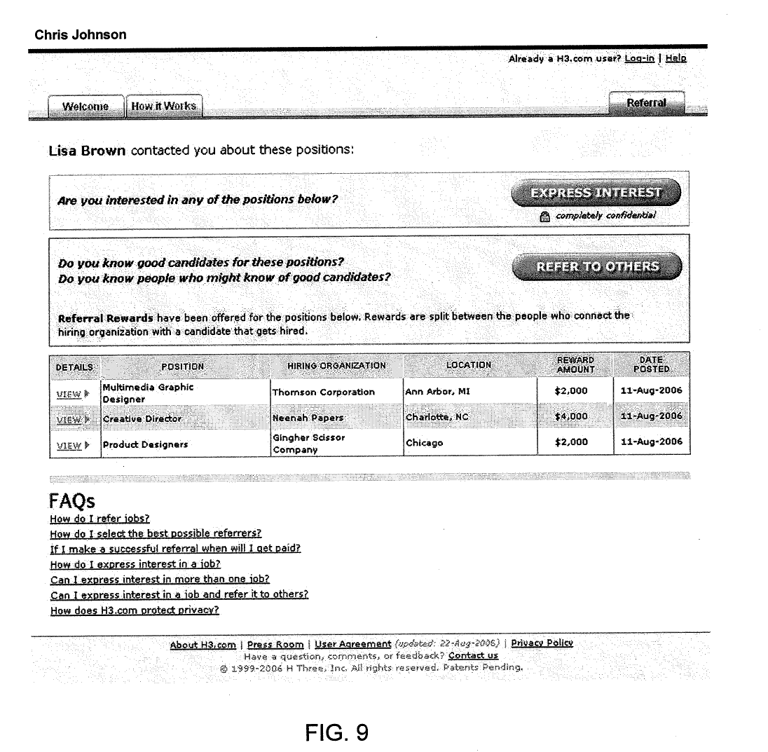

Independently of whether it is Chris or the system that sends the identifier-incorporating message to Mary, Mary will then send the received identifier to the system if she wants the system to send her information about the listing. In the illustrated embodiment, she does this by clicking on a hyperlink in the referral e-mail message that she receives, and the referral-tracking system responds by sending her browser a web page such as one of those that FIG. 9 illustrates. But other embodiments may additionally or instead accept other modes of submitting referral identifiers. For example, the recipient may copy a URL into a web browser's address bar or send an e-mail message containing this identifier. Or a plug-in module in the client's e-mail client may detect a referral-tracking-system message, respond to such a message's receipt by presenting the user the options that the illustrated embodiment's web page does in FIG. 9, and respond to a resultant user input by sending the system the received identifier and the user's information, possibly without the user's having to enter that information manually.

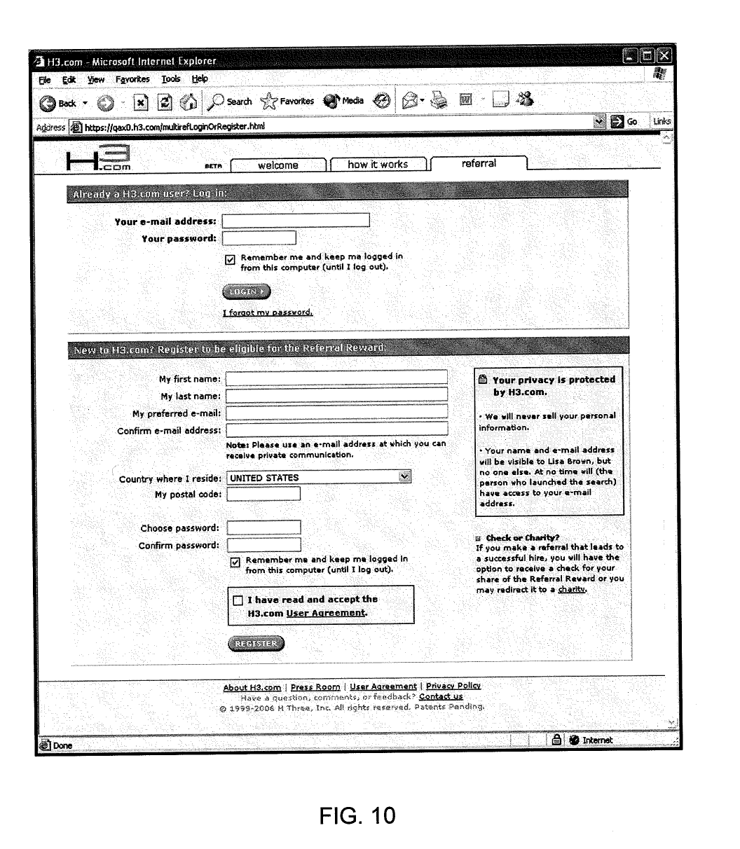

In the scenario we have assumed, though, Mary's browser receives a web page, such as the one that FIG. 9 depicts, that offers the recipient the choice between expressing interest in a listing and referring it to others. In the illustrated embodiment, a recipient who makes the latter choice (by clicking on “Refer to Others”) receives a further web page, similar to the one that FIG. 6 depicts, that enables him to choose among the listings. By clicking on a button provided by that web page, the erstwhile recipient becomes a requester, asking that the system issue a referral identifier that associates him with the chosen listing or listings as a potential referrer thereof. To make that association, the system will need identifying information about the requester, and for that purpose it may use a web-page interface such as the one that FIG. 10 depicts. As that web page indicates, a requester who has entered such information in a previous session can avoid repeating that operation; he can enter a password and user name (here, an e-mail address) by which the system can retrieve the previously supplied identifying information. In any event, the system responds to the identifier request in the manner that was explained above in connection with FIG. 5.

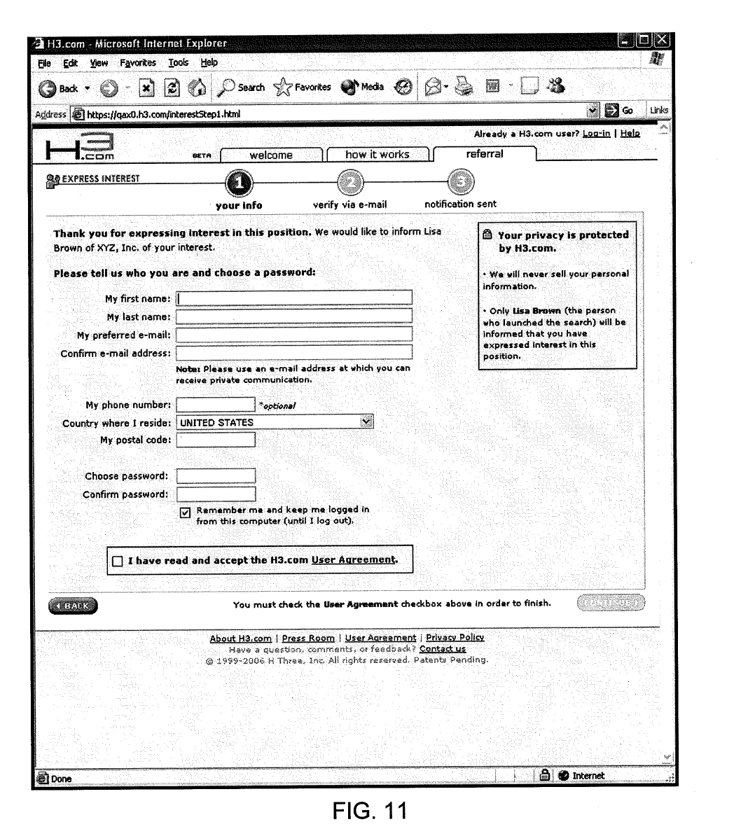

If the recipient clicks on FIG. 9's “Express Interest” button instead of its “Refer to Others” button, the illustrated embodiment sends him a web page by which he chooses among the listings, and the system responds to that choice by using a web page such as that of FIG. 11 to elicit contact information from him. The system may then confirm the recipient's (now, requester's) interest and e-mail address by sending to the requester-entered e-mail address a verification e-mail message. The verification e-mail message may include a hyperlink that incorporates an identifier associated with the listing and the requester, and the requester's web browser would send the incorporated identifier to the system in a message when the requester clicks on the hyperlink (or copies its referred-to URL into the address bar of a web browser). The illustrated embodiment responds to that transmission by notifying the originator of the requester's interest.

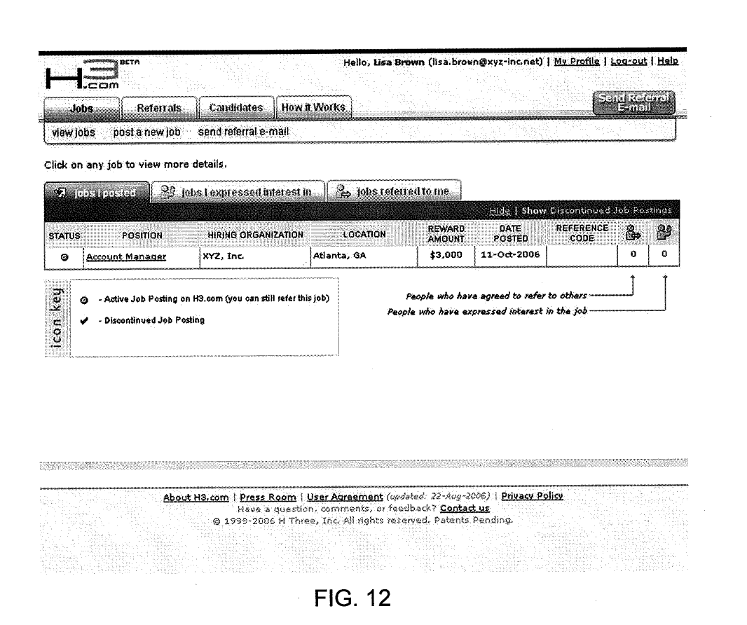

The originator may be notified of the requester's interest in any appropriate way, such as in an e-mail message from the system. Independently of such messages, though, the originator may check on responses in the illustrated embodiment by logging on to the system and obtaining a web-page-style report such as the one that FIG. 12 depicts. As that drawing shows, a user can see how many requests for referral identifiers have resulted from it and how many parties have expressed interest in it. If anyone has expressed interest, the user can obtain details and contact the interested requester at the e-mail address the requester provided. Additionally, that web page includes tabs that the user the user can click on to get information about listings of which that user is not the originator, e.g., listings he has expressed interest in or referred.

Different embodiments may differ in how much information they share with the originator. For example, by logging into the system and reviewing the status of a listing, the originator may be provided with information about the number of times the listing was referred but not the names of the requesters who referred the listing. Alternatively, the originator may be shown the names of the requesters directly linked to the originator but not the names of requesters further along the referral chains. In this way, the originator may obtain information about how many additional unique identifiers have been requested, while the confidentiality of subsequent requesters' contact networks is preserved. Or, if confidentiality is not required, the originator may be shown the complete referral chains.

The system may allow the originator to look at referrals in a multi-referral context if they have been referred in that way. For example, to help an originator determine effective groupings of job listings, the system may allow an originator to see what other listings have been grouped with a particular listing. This may help an originator determine which types of job listings out of a large group of listings are being referred and design listings and groupings accordingly.

In the illustrated embodiment, requesters who are not originators are not notified that a subsequent requester has expressed interest in the listing, although they may be in other embodiments. Also, a requester can express interest in only one listing at a time in the illustrated embodiment even if many similar listings are available to him. In other embodiments, a requester may be able to, say, check a box next to each listing in which the requester is interested and thereby cause expressions of interest to be sent simultaneously to all those listings' originators by, e.g., clicking on a “Continue” or other transmission-triggering button.

As was mentioned above in connection with FIG. 12, the originator can log onto the system to obtain a report on referrals and expressions of interest. The originator may also log onto the system to change a listing's status to indicate that, for example, the listing has been fulfilled or partially fulfilled (e.g., that some or all jobs in the listing have been filled, the listed real estate sold, etc.) and/or to identify the requester who took a listed position. Some embodiments may be so arranged that a requester (for example, a requester ultimately hired to fill a listed position) can claim that the status of the listing should be changed to reflect that a listed position has been taken. In such an embodiment, the system would typically send the originator a confirmation e-mail inviting the originator to confirm that a listed job has been filled, and the originator may do that by, e.g., logging into the system or clicking on a hyperlink that the e-mail contains. The originator may also withdraw a listing or otherwise change its status for any reason at any time. For example, an originator may wish to suspend a search for candidates temporarily in order to have an opportunity to interview candidates that have already been identified. So some embodiments may permit the originator to designate a listing as temporarily inactive and at a later time change the listing's status back to active. In the illustrated embodiment, listing table 123 includes a status column whose contents indicate whether corresponding listings are active, inactive, withdrawn, etc.

There are circumstances in which it is desirable for the system to generate a set of all user identifiers or referral identifiers in a chain leading from the originator to a particular requester. In that context, an identifier is a given identifier's ancestor if it is the given identifier's parent or an ancestor of the given identifier's parent. It may similarly be desirable for the system to generate a set of “offspring” identifiers in one or more chains leading from a particular requester to subsequent requesters. An identifier is a given identifier's offspring if it is the given identifier's child or an offspring of the given identifier's child. The individual referral identifiers associated with a common multi-referral identifier may have the same or a different set of ancestors and offspring.

The system may compute the set of ancestors and/or offspring in response to a request for information about the status of a listing's referral chain. The set of ancestors and/or offspring may then be used to provide that information to the originator. In addition, the system may use a set of ancestors to determine the distribution of a reward. When the system is informed that a requester has been hired for a listed job, it is thereby at least implicitly informed of which referral chain led to that requester. When the system is told which applicant fulfilled the listing, it finds that applicant in that listing's applicant list and thereby identifies the referral that was the fulfillment's proximate cause. It then identifies that referral identifier's ancestors and uses the resultant ancestor set to generate an output. The system may also be arranged to generate an output based on an ancestor set and/or an offspring set for other reasons.

The output can take many forms. In some cases, for example, it may be an indication of how effective various people are as referrers. In the illustrated example, though, the output is an indication of how the reward is to be shared. The simplest approach is for each referrer listed in an ancestor referral to receive an equal share of the award. But the system may instead award unequal shares, and outside information may be relied on to arrive at the distribution. For example, the system may refer to a database of all requesters who have made referrals in the past, and it may allocate to eligible requesters shares proportional to the numbers of listings they have previously referred. Other methods of apportioning shares among requesters in the originator-to-fulfiller referral chain may be employed, too.

Occasionally, more than one referral may be identified as the proximate cause of the fulfillment: more than one branch of the referral tree may connect the originator to the requester who fulfilled the listing. In such a case, the reward may be distributed to the requesters in all branches that lead to the list-fulfilling requester, or it may, say, be distributed only among the requesters in the branch that was activated first.

For example, if an originator sends a referral-identifier-containing message to requesters A and B, who both elect to refer the listing to C, C will receive two referral-identifier-containing messages: one message from A, containing a hyperlink incorporating a referral identifier associated with the listing and with A; and one message from B, containing a hyperlink incorporating an identifier associated with the listing and with B. If C clicks on one of the hyperlinks, elects to express interest in the listing, and eventually fulfills the listing, some embodiments may determine whether the reward goes to A or B by whether the identifier incorporated in the hyperlink that C clicked on was from A's or B's branch of the tree. If C clicked on both A's and B's hyperlinks, the system may assign the reward to both branches or only to one (for example, the branch of the tree that C clicked on first).

Different embodiments may infer different referral-chain topologies from the same set of user actions. This can result from different approaches to enforcing identifier uniqueness, or, viewed another way, from different concepts of what a referral identifier is. To appreciate this, consider as a first embodiment a multiple-listing referral-tracking system that supports the following operational scenario. First, an originator O is issued multi-referral identifier M1 associated with referral identifiers R1, R2, and R3 and sends it to acquaintances A and B. Second, A uses multi-referral identifier M1 to obtain his own identifier to refer the listings associated with R1 and R2 further. A is accordingly issued a multi-referral identifier M2 associated both with referral identifier R4, which represents a child of the referral that R1 represents, and with referral identifier R5, which represents a child of the referral that R2 represents, and sends the multi-referral identifier to acquaintance B. Third, B responds to the message from A by using multi-referral identifier M2 to obtain his own identifier and use that identifier to refer the listing associated with L1 further. B is issued referral identifier R6, which represents a child of the referral represented by R4, and sends it to acquaintance C. Fourth, B responds to the previous e-mail message from O by using multi-referral identifier M1 to refer listing L1 again. B obtains referral identifier R7, which represents a child of the referral represented by R1, and sends it to D, who takes the job.

For the sake of example, we assume here that the system uses referral tables of the type that FIG. 2 depicts. The actions just described cause the first embodiment under consideration to place seven entries into the referral table, namely, a respective entry for each of the referral identifiers R1, R2, R3, R4, R5, R6, and R7. Note that, although each referral identifier is associated with a corresponding user and listing, the associations of user-listing combinations with identifiers are not unique; the entries for R6 and R7 have the same user-listing combination. In this first embodiment, that is, the concept of referral can be thought of a coupled only loosely to that of which user is doing the referring. And, without more, the referral chain would be deemed to be O-B-D, because R1 is the parent of R7, which is the identifier that D received: B alone would get the reward (if the originator cannot share).

Other embodiments may be so arranged as to couple the concepts of referral and referrer more tightly. For example, consider a second example embodiment, which differs from the one just described in that its response to B's second request—i.e., to a request for a second referral identifier associated with the same combination of user and listing—is to deny the request or, what amounts to the same thing, is just to send B the same referral identifier it sent B previously. In that case, the referral chain would be deemed to be O-A-B-D: A and B would share the reward. Note that in this embodiment the parent-child relationships between referrals are equivalent to parent-child relationships between users. To emphasize that, FIG. 2's table 125 includes a “parent user” column even though that column's information is redundant in view of the “parent identifier.”

As was explained above, the way in which a requester makes a request is typically to send the system a message that identifies the listing and the referring entity (although, if a party referred without having requested a referral identifier, the identified entity may not be the immediate referrer). As was also explained above, the identifier that represents that information may additionally, if the requester asked that the system itself send the referral, identify the referral's target. It is often advantageous for the system to have this information, because it provides more insight into the “conversion rate,” i.e., the rate at which recipients actually participate.

To appreciate this, consider a scenario in which a requester has sent a message to a large number of other people without informing the system of the intended recipients. If the web page identified by the message was downloaded a large number of times but only one expression of interest resulted, a plausible conclusion is that the web page was not very effective at drawing interest in the listing. Another possibility, though, is that only one or a very few people actually downloaded that web page but that someone who did download it did so repeatedly in trying to make up his mind. In that case, the web page was relatively effective, but most people ignored the e-mail message.

Distinguishing between the two situations is quite important in determining how to increase response to a recruitment campaign, but the system is unable to distinguish between them if the recipient had received his initial message from the referring user rather than from the system, i.e., if the identifiers that came from the recipient identified only the referrer and listings but not the target contact. If it is the system that sends that initial message, though, the identifier that was sent to the recipient identifies the recipient, so the web page received by the recipient can, too, and so can the message his browser sends the system when he clicks on a button in that web page. As a result, the system can count not just how many downloads occurred but also how many different recipients were involved.

Moreover, the illustrated embodiment obtains this advantage without suffering any resultant lack of participation. This is because the system gives the user an option: as FIG. 6 shows, the user can choose between (1) disclosing the target contact to the system and (2) withholding that information. So the system is not denied participation by those who prefer not to disclose their contacts, but it obtains conversion-rate information from those who do not have that preference. And the fact that not all referrers disclose their targets does not prevent other referrers' information from being valid; projections from a portion of a population are highly informative.

Accordingly, the present invention enhances referral-system usefulness and therefore constitutes a significant advance in the art.

What is claimed is:

1. A computer system configured as a referral-tracking system operable to:
A) issue referral identifiers, each of which the referral-tracking system associates with a referrer and at least one listing, each referral identifier representing, for each listing associated therewith, a respective referral thereof by the referrer associated with that referral identifier, the referral-tracking system being operable to issue some said referral identifiers as multiple-referral identifiers, with each of which the referral-tracking system associates a plurality of listings whose referrals by the referrer are represented by that multiple-referral identifier;
B) respond to receipt, from a requester, of a multiple-referral identifier and a request for a further referral identifier, which request specifies at least one of the listings represented by the multiple-referral identifier and indicates whether the further referral identifier should represent referral to a recipient specified by that requester, by:
i) issuing such a further referral identifier associated by the referral-tracking system with the specified recipient if that indication is affirmative and with no recipient if that indication is negative;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded parent-child relationships; and
D) generate one or more chain-dependent outputs that it determines from the chain of referrals thereby tracked.

2. A computer system as defined by claim 1 wherein the referral-tracking system:
A) sends the further referral identifier to the specified recipient if the request indicates that the further referral identifier should represent referral to a recipient; and
B) otherwise sends the further referral identifier to the requester.

3. A computer system as defined in claim 2 wherein, when the request specifies a plurality of the listings represented by the multiple-referral identifier received from the requester and indicates that the further referral identifier should represent referral to a recipient specified by that requester, the referral-tracking system associates that recipient and plurality of listings with the further referral identifier.

4. A computer system as defined in claim 1 wherein the referral-tracking system in some circumstances associates with the further referral identifier a plurality of listings specified by the request.

5. A computer system as defined in claim 4 wherein the referral-tracking system in some circumstances associates a recipient specified by the requester with the further referral identifier that it associates with a plurality of listings.

6. A storage medium containing machine instructions readable by a computer system to configure the computer system as a referral-tracking system operable to:
A) issue referral identifiers, each of which the referral-tracking system associates with a referrer and at least one listing, each referral representing, for each listing associated therewith, a respective referral thereof by the referrer associated with that referral identifier, the referral-tracking system being operable to issue some said referral identifiers as multiple-referral identifiers, with each of which the referral-tracking system associates a plurality of listings whose referrals by the referrer are represented by that multiple-referral identifier;
B) respond to receipt, from a requester, of a multiple-referral identifier and a request for a further referral identifier, which request specifies at least one of the listings represented by the multiple-referral identifier and indicates that the further referral identifier should represent referral to a recipient specified by that requester, by
i) issuing such a further identifier associated by the referral-tracking system with the specified recipient;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded parent-child relationships; and
D) generate one or more chain-dependent outputs that it determines from the chain of referrals thereby tracked.

7. A storage medium as defined by claim 6 wherein the referral-tracking system:
A) sends the further referral identifier to the specified recipient if the request indicates that the further referral identifier should represent referral to a recipient; and
B) otherwise sends the further referral identifier to the requester.

8. A storage medium as defined in claim 7 wherein, when the request specifies a plurality of the listings represented by the multiple-referral identifier received from the requester and indicates that the further referral identifier should represent referral to a recipient specified by that requester, the referral-tracking system associates that recipient and plurality of listings with the further referral identifier.

9. A storage medium as defined in claim 6 wherein the referral-tracking system in some circumstances associates with the further referral identifier a plurality of listings specified by the request.

10. A computer system as defined in claim 9 wherein the referral-tracking system in some circumstances associates a recipient specified by the requester with the further referral identifier that it associates with a plurality of listings.

11. A referral-tracking method comprising employing a computer system to:
A) issue referral identifiers, each of which is associated with a referrer and at least one listing, each referral representing, for each listing associated therewith, a respective referral thereof by the referrer associated with that referral identifier, some said referral identifiers being issued as multiple-referral identifiers, with each of which is associated a plurality of listings whose referrals by the referrer are represented by that multiple-referral identifier;
B) respond to receipt, from a requester, of a multiple-referral identifier and a request for a further referral identifier, which request specifies at least one of the listings represented by the multiple-referral identifier and indicates that the further referral identifier should represent referral to a recipient specified by that requester, by
i) issuing such a further identifier associated by the referral-tracking system with the specified recipient;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the issued referral identifiers to track a chain of referrals of the listings in accordance with the recorded parent-child relationships; and
D) generate one or more chain-dependent outputs determined from the chain of referrals thereby tracked.

12. A method as defined by claim 11 wherein:
A) the further referral identifier is sent to the specified recipient if the request indicates that the further referral identifier should represent referral to a recipient; and
B) the further referral identifier is otherwise sent to the requester.

13. A method as defined in claim 12 that includes, when the request specifies a plurality of the listings represented by the multiple-referral identifier received from the requester and indicates that the further referral identifier should represent referral to a recipient specified by that requester, associating that recipient and plurality of listings with the further referral identifier.

14. A method as defined in claim 11 that in some circumstances associates with the further referral identifier a plurality of listings specified by the request.

15. A storage medium as defined in claim 14 that in some circumstances includes associating a recipient specified by the requester with the further referral identifier associated with a plurality of listings.

16. A computer system configured as a referral-tracking system operable to:
A) issue referral identifiers, each of which the referral-tracking system associates with a referrer and at least one listing, each referral identifier representing, for each listing associated therewith, a respective referral thereof by the referrer associated with that referral identifier, the referral-tracking system being operable to issue some said referral identifiers as directed multiple-referral identifiers, with each of which the referral-tracking system associates a respective recipient and a plurality of listings whose referrals to that recipient by the referrer are represented by that directed multiple-referral identifier;
B) respond in at least some circumstances to receipt, from a requester, of a multiple-referral identifier and a request for a further referral identifier, which request specifies a plurality of the listings represented by the multiple-referral identifier and identifies a recipient, by:
i) issuing such a further referral identifier associated by the referral-tracking system with the specified recipient;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded parent-child relationships; and
D) generate one or more chain-dependent outputs that it determines from the chain of referrals thereby tracked.

17. A storage medium containing machine instructions readable by a computer system to configure the computer system as a referral-tracking system operable to:
A) issue referral identifiers, each of which the referral-tracking system associates with a referrer and at least one listing, each referral identifier representing, for each listing associated therewith, a respective referral thereof by the referrer associated with that referral identifier, the referral-tracking system being operable to issue some said referral identifiers as directed multiple-referral identifiers, with each of which the referral-tracking system associates a respective recipient and a plurality of listings whose referrals to that recipient by the referrer are represented by that directed multiple-referral identifier;
B) respond in at least some circumstances to receipt, from a requester, of a multiple-referral identifier and a request for a further referral identifier, which request specifies a plurality of the listings represented by the multiple-referral identifier and identifies a recipient, by:
i) issuing such a further referral identifier associated by the referral-tracking system with the specified recipient;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded parent-child relationships; and
D) generate one or more chain-dependent outputs that it determines from the chain of referrals thereby tracked.

18. A referral-tracking method that comprises using a computer system to:
A) issue referral identifiers, each of which is associated with a referrer and at least one listing, each referral identifier representing, for each listing associated therewith, a respective referral thereof by the referrer associated with that referral identifier, some said referral identifiers being issued as directed multiple-referral identifiers, with each of which is associated a respective recipient and a plurality of listings whose referrals to that recipient by the referrer are represented by that directed multiple-referral identifier;
B) respond in at least some circumstances to receipt, from a requester, of a multiple-referral identifier and a request for a further referral identifier, which request specifies a plurality of the listings represented by the multiple-referral identifier and identifies a recipient, by:
i) issuing such a further referral identifier associated by the referral-tracking system with the specified recipient;
ii) sending the requester or the specified recipient a message that incorporates the further referral identifier; and
iii) recording a parent-child relationship between (a) each listing's referral represented by the further referral identifier and (b) the same listing's referral represented by the received multiple-referral identifier;
C) use receipt by the referral-tracking system of the issued referral identifiers to track a chain of referrals of the listings in accordance with the recorded parent-child relationships; and
D) generate one or more chain-dependent outputs determined from the chain of referrals thereby tracked.
